(19) United States
(12) Patent Application Publication
(10) Pub. No.: US 2010/0282355 A1
(43) Pub. Date: Nov. 11, 2010

(54) MULTILAYER CONDUIT

(75) Inventors: Andreas Seyler, Gruendau (DE); Wilfried Zuelch, Gelnhausen (DE); Marc Van Hooren, Freigericht (DE)

Correspondence Address: BUCHANAN, INGERSOLL & ROONEY PC, POST OFFICE BOX 1404, ALEXANDRIA, VA, 22313-1404, US

(73) Assignee: Veritas AG, Gelnhausen (DE)

(21) Appl. No.: 12/746,213

(22) PCT Filed: Nov. 20, 2008
(86) PCT No.: PCT/EP2008/009839

§ 371 Date: Jun. 30, 2010

(30) Foreign Application Priority Data
Dec. 6, 2007 (DE) 10 2007 058 721.1

(51) Int. Cl. B05B 1/00; B32B 1/08; F16L 9/14

(52) U.S. Cl. 138/140; 428/36.91; 428/36.2; 428/36.1

(57) ABSTRACT

A multi-layer conduit which can, for example, transport fuels, includes at least one blocking layer and one top layer. The blocking layer can include a thermoplastic fluoroelastomer and/or a thermoplastic fluoroelastomer vulcanisate. A tank filling device can include at least one filling nozzle in which the multi-layer conduit is provided.

The present invention relates to a multilayer conduit, particularly for the transport of fuels, comprising at least one barrier layer and one cover layer.

Multilayer conduits of this type for use in a fuel line system of a motor vehicle or another vehicle are generally known. The barrier layer thereof is to prevent the permeation of fuel vapors and gases of the fuel present in the multilayer conduit, while the cover layer is provided, inter alia, to effectively counteract the negative influence of environmental impacts on the multilayer conduit, e.g. the influence of ozone in the air.

Frequently, fluoroelastomers such as copolymers of vinylidene fluoride (VDF) and hexafluoropropylene (HFP) or terpolymers of tetrafluoroethylene (TFE), HFP and VDF, or fluorothermoplastics of a similar chemical composition, such as the so-called THV, are used for the barrier layer, as these materials have good barrier properties to fuel vapors and gases.

The drawback involved by the use of said fluoroelastomers resides in the relatively complicated processing thereof and, more importantly, it only permits the realization of comparatively thick barrier layers. However, thick barrier layers prevent narrow bending radii, which are necessary, especially in modern vehicles, for the laying of the multilayer conduits inside the engine compartment or the vehicle body due to very confined space conditions.

Therefore, the invention is based on the object to provide a multilayer conduit which is flexible, but has nonetheless good barrier properties with respect to fuel vapors and gases. Moreover, it is an object of the invention to constitute a multilayer conduit which is easy to manufacture and, thus, cost-efficient.

According to the invention this object is achieved with a multilayer conduit of the above-mentioned type, whose barrier layer includes a thermoplastic fluoroelastomer (F-TPE) and/or a thermoplastic fluoroelastomer vulcanisate (F-TPE-V).

In addition, the invention also relates to a tank filling device, which comprises at least one filling nozzle and in which the multilayer conduit is provided.

As compared with fluoroelastomers, F-TPE's and F-TPE-V′s can be easily processed in ordinary thermoplastic extruders, thereby allowing the manufacture of thin films. Thus it is possible to manufacture the barrier layer of the multilayer conduit according to the invention extremely thin and in an easy fashion. Also, the multilayer conduit is particularly flexible and versatile in comparison with conventional conduits because the installation space in modern vehicles is frequently very constricted. Furthermore, such a flexible multilayer conduit can be further expanded at the mold ends. Finally, also a reduction of costs is possible in comparison with multilayer conduits of fluoroelastomers, namely due to the smaller layer thickness. The base materials used for the barrier layer may be, on the one hand, block copolymers (Type ABA: A =hard phase, fluorothermoplastic e.g. ETFE, PVDF; B=soft segment, fluoroelastomer e.g. terpolymer of VDF, TFE, HFP) and, on the other hand, TPE-V (blend of vulcanized fluoroelastomer particles in fluorothermoplastic phase). As is common practice, the adhesion between the individual layers is realized by means of special adhesion agents in the intermediate or adhesion layer, respectively.

The dynamic property of the multilayer conduit can be adjusted by the molecular weight (chain length) of the thermoplastic matrix (e.g. ETFE). Elastomeric properties can be defined by the content and type of the used fluoroelastomers (cross-linked copolymers or terpolymers). It is likewise conceivable that the multilayer conduit according to the invention comprises a barrier layer that is completely made of only the two materials thermoplastic fluoroelastomer (F-TPE) and thermoplastic fluoroelastomer vulcanisate (F-TPE-V). Moreover, the barrier layer may be completely made of only one thermoplastic fluoroelastomer (F-TPE) or of one thermoplastic fluoroelastomer vulcanisate (F-TPE-V).

It may be an advantage that the multilayer conduit also comprises an intermediate layer. This layer can influence, for instance, the mechanical properties of the multilayer conduit in a favorable manner, or it can assume the connecting function between the barrier layer and the cover layer in terms of an adhesive layer.

Moreover, it can be advantageous that the barrier layer is disposed between an inner layer and the cover layer. Thus, the barrier layer is not in direct contact with the fuel.

Also, it can be advantageous that the barrier layer includes a block copolymer of a fluorothermoplastic, preferably ETFE or PVDF or FEP or E-CTFE, and a fluoroelastomer, preferably terpolymer of VDF, TFE and HFP. These materials have rubber-like properties and, at the same time, have excellent barrier properties with respect to fuel vapors and gases.

Also, it can be advantageous that the barrier layer is made of a block copolymer of fluorothermoplastic, preferably ETFE or PVDF or FEP or E-CTFE, and of a fluoroelastomer, preferably terpolymer of VDF, TFE and HFP.

Also, it may be favorable that the barrier layer includes a block copolymer of a fluorothermoplastic, preferably ETFE or PVDF or FEP or E-CTFE, and a copolymer, preferably of VDF and HFP. Thermoplastic elastomers of block copolymers are characterized by a two-phase structure: crystalline thermoplastic (hard phase) and amorphous component (soft phase), with the crystalline phase forming the physical cross-linking points.

It may be favorable that the barrier layer includes a thermoplastic elastomer vulcanisate (TPE-V) of fluorothermoplastic, preferably ETFE or PVDF or FEP or E-CTFE, and fluoroelastomer, preferably terpolymer of VDF, TFE and HFP. TPE-V′s are two-phase mixtures of thermoplastic and a cross-linked elastomer component.

It may be favorable that the barrier layer has a thickness of less than 0.2 mm, and preferably a thickness between 0.05 and 0.20 mm. Thus, the barrier layer is extremely flexible, which permits a very flexible configuration also of the multilayer conduit as a whole. At the same time, said thicknesses of the barrier layer help to obtain the desired barrier properties.

Also, it may be favorable that the cover layer and/or the inner layer include(s) a polymeric material, preferably an elastomer, or a thermoplastic or a thermoplastic elastomer. These materials permit a manufacture of the multilayer conduit which is, all in all, simple and economical.

In addition, it may be favorable that the inner layer includes an NBR elastomer or ECO or FPM, and is preferably made thereof. This permits the realization of a particularly flexible and functional multilayer conduit.

Furthermore, it may be favorable that the cover layer includes an ozone-resistant material, such as chlorinated polyethylene (CM) or chlorosulfonated polyethylene (CSM) or an NBR elastomer or a chloroprene elastomer or ECO or AEM or EVM or TPE's (polyolefins). The use of these materials results in multilayer conduits which are especially well protected against heat and environmental impacts.

It may be an advantage that the cover layer and the inner layer each have a thickness between 0.5 and 3 mm, and preferably a thickness of 1 to 2 mm. These thicknesses allow to obtain the desired high flexibility of the multilayer conduit, along with conservation of material and resources.

Here, it may be an advantage that the intermediate layer includes a polymeric material, preferably an elastomer or a thermoplastic or a thermoplastic elastomer.

Moreover, it can be an advantage that the multilayer conduit comprises at least two intermediate layers and that the barrier layer is arranged there between. This results is a particularly well protected arrangement of the barrier layer.

It may prove to be favorable that the multilayer conduit comprises at least one reinforcing layer. This reinforcing layer increases, inter alia, the pressure resistance and mechanical loadability of the multilayer conduit.

Here, it can be an advantage that the reinforcing layer has a knitted or braided structure. These structures result in a particularly high mechanical loadability of the reinforcing layer, along with a relatively small material input and a correspondingly low weight. Also, it may here be advantageous that the reinforcing layer includes a metallic and/or textile and/or polymeric and/or organic material and/or inorganic material.

It may prove to be favorable that the reinforcing layer is disposed between two adjacent layers or in one of the layers of the multilayer conduit. This allows the effective protection of the reinforcing layer against the influence of the ambient condition of the multilayer conduit and against mechanical impact.

It may also prove to be favorable that the multilayer conduit is provided with at least one heating device. This device allows, especially in the cold season, the fuel to be preheated, which results in a more effective fuel combustion. Moreover, if diesel fuel is used, the gelling thereof is avoided.

A particularly easy and economical realization is achieved if the heating device comprises at least one heating wire.

Moreover, it may prove to be favorable that the heating wire extends at least section-wise within one of the layers of the multilayer conduit. Thus, it is well protected against environmental influences and mechanical stress.

Also, it may prove to be favorable that the heating wire is woven or knitted or braided at least section-wise into the reinforcing layer. This allows a particularly easy integration of the heating wire—together with the reinforcing layer—in the multilayer conduit.

Specifically, it may prove to be favorable that the heating wire is disposed spiral-shaped or ring-shaped along the multilayer conduit. This results in a particularly high and constant heating capacity.

In an advantageous embodiment of the multilayer conduit the same comprises three layers, wherein the barrier layer is inside and includes F-TPV, and wherein the intermediate layer joining the barrier layer on the outside includes an epichlorohydrin elastomer (ECO) or NBR or AEM, and wherein the cover layer joining the intermediate layer on the outside includes ECO or NBR or AEM or EVM or CR or CM or all elastomers or TPE's coming into question.

The advantage of this modification is that small bending radii can be realized and that the imperviousness is excellent owing to the elastomeric properties (settlement with respect to THV and other thermoplastic materials).

In an additional advantageous embodiment of the multilayer conduit the structure comprises four layers, wherein the innermost layer includes an NBR elastomer, and wherein the barrier layer joining on the outside includes an F-TPV, and wherein the layer joining the barrier layer on the outside likewise includes an NBR elastomer, and wherein the cover layer joining this layer on the outside and being the outermost layer includes ECO or NBR or AEM or EVM or CR or CM or all elastomers or TPE's coming into question.

In this modification the permeation behavior can be adjusted analogously to the dynamic resistance by means of the degree of crystallization and the chain length/molecular weight (similar to THV 500 vs. THV 800). Moreover, the universal imperviousness is advantageous because frequently the quality of a tank filling nozzle of so-called tank filling devices is inferior. If the quality of the tank filling nozzle is poor, a good sealing effect can be achieved as a result of the elastomeric inner layer.

In another advantageous embodiment of the multilayer conduit the structure comprises five layers, wherein the inner layer includes an NBR elastomer, and wherein the barrier layer joining the inner layer on the outside includes an F-TPV, and wherein the layer joining the barrier layer on the outside likewise includes an NBR elastomer, and wherein the reinforcing layer joining this layer on the outside includes a knitted or braided structure of polymeric fibers, and wherein the cover layer joining the reinforcing layer on the outside and being the outermost layer includes ECO or NBR or AEM or EVM or CR or CM or all elastomers or TPE's coming into question.

Moreover, the concept according to the invention can also be transferred to tank filling devices which comprise at least one filling nozzle and include a multilayer conduit in correspondence with one of the above embodiments. Such tank filling devices are usable in motor vehicles in a particularly advantageous manner.

The features and advantages of the invention are explained in more detail in the following description, with reference to the accompanying figures which illustrate the following:

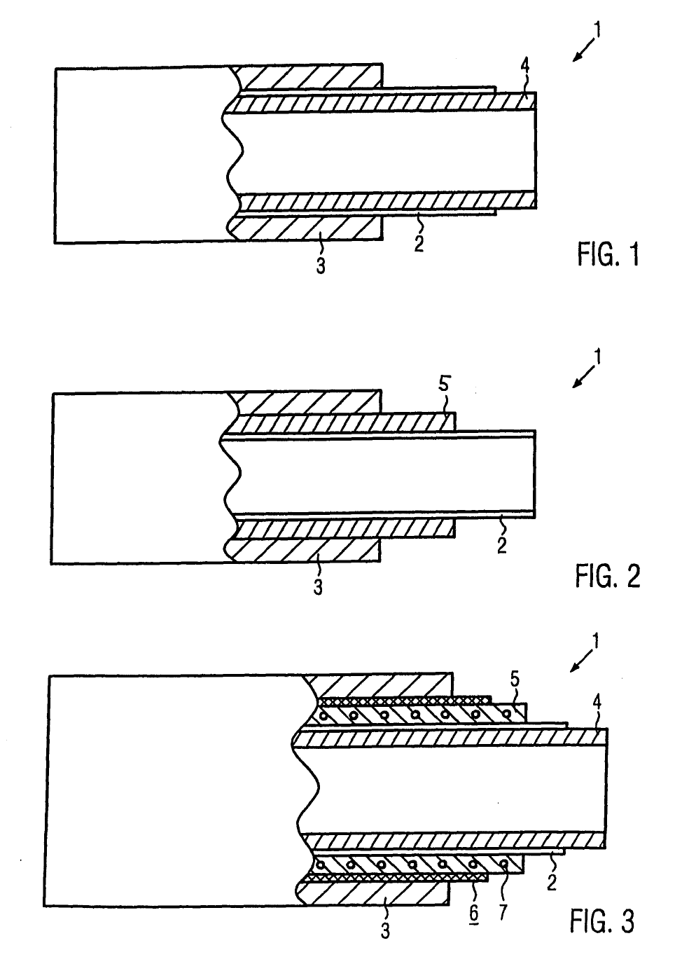

FIG. 1 shows a sectional view of a first embodiment of the multilayer conduit according to the invention,

FIG. 2 shows a sectional view of a second embodiment of the multilayer conduit according to the invention,

FIG. 3 shows a sectional view of a third embodiment of the multilayer conduit according to the invention.

In the different drawings like or corresponding parts are each provided with like reference numbers. The representation shown in FIG. 1, which is not true to scale, shows a section though a first embodiment of the multilayer conduit according to the invention, with the innermost layer being formed by the inner layer 4 which is made of an NBR elastomer. The thickness of the inner layer 4 is about 1-2 mm. This layer is joined by the barrier layer 2 on the outside, which has a thickness of 0.05-0.2 mm and is made of F-TPE. The outermost layer is formed by the cover layer 3 of CM, the thickness of which is 1.0-2.5 mm.

The representation shown in FIG. 2, which is not true to scale, shows a section though a second embodiment of the multilayer conduit according to the invention. As opposed to the first embodiment according to FIG. 1, the barrier layer 2 made of F-TPE forms the innermost layer with a thickness of 0.05-0.2 mm. This layer is joined on the outside by the intermediate layer 5, which is made of an ECO elastomer and has a thickness of about 1-2.5 mm. The cover layer 3 joining this intermediate layer 5 on the outside is also made of an ECO elastomer and has a thickness of about 1-2.5 mm.

The representation shown in FIG. 3, which is not true to scale, shows a section though a third embodiment of the multilayer conduit according to the invention. The corresponding multilayer conduit comprises five layers, wherein the innermost layer is formed by the inner layer 4, which is made of an NBR elastomer and has a thickness of about 0.5-1.5 mm. This layer is joined on the outside by the barrier layer 2, which is made of F-TPE and has a thickness of 0.05-0.2 mm. On top of the barrier layer 2 the intermediate layer 5 is arranged, which is made of an NBR elastomer and has a thickness of 1 mm. The heating wire 7 is disposed inside the intermediate layer 5 and extends along the multilayer conduit 1 in a spiral-shaped geometry. The outside of the intermediate layer 5 is joined by the reinforcing layer 6, which is made of knitted polymer fibers. The cover layer 3, which is made of CM and has a thickness of about 1-2 mm, serves as the outermost layer.

### LIST OF REFERENCE NUMBERS

1 multilayer conduit

2 barrier layer

3 cover layer

4 inner layer

5 intermediate layer

6 reinforcing layer

7 heating wire

1. Multilayer conduit comprising:
at least one barrier layer; and
at least one cover layer, wherein the barrier layer includes a thermoplastic fluoroelastomer (F-TPE) and/or a thermoplastic fluoroelastomer vulcanisate (F-TPE-V).

2. Multilayer conduit according to claim 1, wherein the multilayer conduit additionally comprises an intermediate layer.

3. Multilayer conduit according to claim 1, wherein the barrier layer is disposed between an inner layer and the cover layer.

4. Multilayer conduit according to claim 1, wherein the barrier layer includes a block copolymer of a fluorothermoplastic, and a fluoroelastomer, and/or the barrier layer includes a block copolymer of a fluorothermoplastic, and a copolymer

5. Multilayer conduit according to claim 1, wherein the barrier layer is made of a block copolymer of fluorothermoplastic, and of a fluoroelastomer.

6. Multilayer conduit according to claim 1, wherein the barrier layer includes a thermoplastic elastomer vulcanisate (TPE-V) of fluorothermoplastic, and fluoroelastomer.

7. Multilayer conduit according to claim 1, wherein the barrier layer has a thickness of less than 0.2 mm.

8. Multilayer conduit according to claim 1, wherein the cover layer and/or the inner layer include(s) a polymeric material, or a thermoplastic or a thermoplastic elastomer.

9. Multilayer according to claim 1, wherein the inner layer includes an NBR elastomer or ECO or FPM.

10. Multilayer conduit according to claim 1, wherein the cover layer includes an ozone-resistant material,

11. Multilayer conduit according to claim 1, wherein the cover layer and the inner layer each have a thickness between 0.5 and 3 mm.

12. Multilayer conduit according to claim 1, wherein the intermediate layer includes a polymeric material.

13. Multilayer conduit according to claim 1, wherein the multilayer conduit comprises at least two intermediate layers and the barrier layer is arranged there between.

14. Multilayer conduit according to claim 1, wherein the multilayer conduit comprises at least one reinforcing layer and the reinforcing layer has a woven or knitted or braided structure and/or a metallic and/or textile and/or polymeric and/or organic material and/or inorganic material and/or the reinforcing layer is disposed between two adjacent layers or in one of the layers of the multilayer conduit.

15. Multilayer conduit according to claim 1, wherein the multilayer conduit is provided with at least one heating device and the heating device comprises at least one heating wire and preferably the heating wire extends at least section-wise within one of the layers of the multilayer conduit and/or the heating wire is woven or knitted or braided at least section-wise into the reinforcing layer and/or the heating wire is disposed spiral-shaped or ring-shaped along the multilayer conduit.

16. Multilayer conduit according to claim 1, wherein the multilayer conduit comprises three layers, wherein the barrier layer is inside and includes F-TPV, and wherein the intermediate layer joining the barrier layer on the outside includes an epichlorohydrin elastomer (ECO) or NBR or AEM, and wherein the cover layer joining the intermediate layer on the outside includes ECO or NBR or AEM or EVM or CR or CM.

17. Multilayer conduit according to claim 1, wherein the multilayer conduit comprises four layers, wherein the innermost layer includes an NBR elastomer, and wherein the barrier layer joining on the outside includes an F-TPV, and wherein the layer joining the barrier layer on the outside likewise includes an NBR elastomer, and wherein the cover layer joining this layer on the outside and being the outermost layer includes ECO or NBR or AEM or EVM or CR or CM.

18. Multilayer conduit according to claim 1, wherein the multilayer conduit comprises five layers, wherein the inner layer includes an NBR elastomer, and wherein the barrier layer joining the inner layer on the outside includes an F-TPV, and wherein the layer joining the barrier layer on the outside likewise includes an NBR elastomer, and wherein the reinforcing layer joining this layer on the outside includes a knitted or braided structure of polymeric fibers, and wherein the cover layer joining the reinforcing layer on the outside and being the outermost layer includes ECO or NBR or AEM or EVM or CR or CM.

19. Tank filling device comprising:
at least one filling nozzle; and
a multilayer conduit which includes;
at least one barrier laver; and
at least one cover layer wherein the barrier layer includes a thermoplastic fluoroelastomer (F-TPE) and/or a thermoplastic fluoroelastomer vulcanisate (F-TPE-V).
